(19) United States
(12) Patent Application Publication
(10) Pub. No.: US 2026/0126120 A1
(43) Pub. Date: May 7, 2026

(54) ROTARY DISC VALVE

(71) Applicant: Robert Bosch GmbH, Stuttgart (DE)

(72) Inventors: Jongwan Kim, Novi, MI (US); Paul Mason, Dearborn, MI (US); David Toutant, Grosse Pointe Woods, MI (US); James Christopher Franklin, Canton, MI (US)

(21) Appl. No.: 18/939,640

(22) Filed: Nov. 7, 2024

(51) Int. Cl. F16K 11/074

(52) U.S. Cl. CPC F16K 11/074

(57) ABSTRACT

A rotary disc valve is used in a fluid delivery system to control flow of fluid between fluid lines connecting elements of the system. The valve includes a valve body that supports a fixed disc and receives a diverter having a movable disc. The diverter is configured to rotate relative to the valve body about a rotational axis and cooperate with the fixed disc to control fluid flow through the valve body. The fixed disc and the movable disc have through openings that provide fluid flow through the valve according to a fluid flow rate versus diverter position curve or set of curves.

### BACKGROUND

A rotary valve is a type of directional control valve that may be used in a fluid delivery system to control fluid flow and distribution through the system. For example, rotary valves may be used to control the flow of coolant through a vehicle coolant control system. The rotary valve may include a valve body that defines fluid ports and a diverter that is disposed in the valve body. The diverter is shaped to distribute the flow to predetermined fluid ports for certain rotational orientations of the diverter within the valve body and is rotated relative to the valve body to control flow through the valve. In some conventional rotary disc valves, one or more discs are disposed in the valve body. The discs move relative to each other and cooperate to block flow or to direct a full or partial flow to one or more ports in the valve body. In some applications, it may be desirable for a rotary disc valve to control fluid flow while having specific flow characteristics.

### SUMMARY

A thermal management system for an electric vehicle may include a coolant control system having a disc-type rotary fluid valve that can be used by the thermal management system to direct coolant, for example, to cool a drive motor, a charge air heat exchanger, a battery, power electronics modules, the vehicle passenger cabin and/or other vehicle components or systems that require temperature control. For purposes of operational and packaging efficiency, it may be useful to combine multiple components of the vehicle thermal management system into a single, integrated module. Such a module may include the coolant control system, a refrigerant control system or both. The coolant control system may include, for example, one or more circulation pumps, a fluid reservoir, one or more fluid valves, a coolant control system controller, sensors, heat exchangers, etc. A housing of the module may include internal passageways that permit fluid communication between the various components of the system included in the module. Portions of the module housing may be configured to replace housing elements of certain components. For example, a portion of the module housing may be used to provide a lid of a fluid valve and/or fluid valve assembly, whereby the fluid valve assembly is connected to the module housing. For other components, the module may be configured to permit the component to “plug into” an appropriately configured portion of the module housing.

Such complex fluid delivery systems may require a rotary valve that is capable of controlling fluid flow between two, three, four or more individual ports of the valve body. For example, a multi-port rotary disc valve may be used in a coolant control system of an electric vehicle to control flow of coolant fluid between a radiator, an electric drive motor, a battery, vehicle electronics, and/or one or more bypass lines. Moreover, such valves may be required to output fluid having specific flow characteristics from one or more of the ports.

The rotary disc valve may include a valve body (e.g., a valve housing) that provides a valve chamber, the valve body including an inlet port, a first outlet port and a second outlet port that each open to the valve chamber. The valve may include a fixed disc that is disposed in the valve chamber and is fixed relative to the valve body. The valve may include a diverter disposed in the valve chamber. The diverter includes a moveable disc that is parallel to and abuts the fixed disc. The diverter is configured to rotate relative to both the valve body and the fixed disc about a rotational axis. The orientation of the diverter including the movable disc relative to the fixed disc about the rotational axis provides control of the fluid flow from the inlet port to the first and second outlet ports. In addition, each of the movable and fixed discs include through openings that are shaped and dimensioned to output fluid having specific flow characteristics from one or more of the ports. For example, in the illustrated embodiment, the fluid flow from the inlet to either the first or second outlet is controlled to permit fine control of fluid flow volume in one range of valve opening amounts and to permit coarse control of fluid flow volume in another range of valve opening amounts.

In particular, the valve controls fluid flow in such a way that fluid flows through the first outlet port according to a first flowrate versus diverter position curve having a first curve portion and a second curve portion that adjoins the first curve portion. The first curve portion has a first slope that is linear. The second curve portion has a second slope that is linear. The absolute value of the second linear slope is greater than that of the first linear slope. In addition, fluid flows through the second outlet port according to a second flowrate versus diverter position curve. The second flowrate versus diverter position curve is a mirror image of the first flowrate versus diverter position curve relative to a predetermined flowrate. In the illustrated embodiment, the predetermined flowrate intersects the second curve portion of the first flowrate versus diverter position curve.

In some applications, packaging requirements may be such that available space in an axial direction (e.g., in a direction parallel to the valve rotational axis) is limited. In such cases, the rotary disc valve described herein may be advantageous in view of its low profile, e.g., a diameter of the valve body is greater than the axial dimension of the valve body. This is achieved, in part, by use of disc shaped valve components and also by locating the inlet and outlet ports at an end face (for example, at the seat end face) of the valve body rather than locating one or more ports in the cylindrical sidewall of the valve body.

In some aspects, a valve includes a valve body and a diverter. The valve body has an inlet port and an outlet port, and the diverter is rotatably disposed in the valve body. The diverter is configured to control flow through the valve body in such a way that fluid flows through the first outlet port according to a flowrate versus diverter position curve such that the rate of fluid flow through the valve body can be adjusted with a first resolution for a diverter position in a first range of positions and with a second resolution for a diverter position in a second range of positions, and the second resolution is more coarse than the first resolution.

In some embodiments, the second range of positions is non-overlapping with the first range of positions, and each position of the second range of positions corresponds to a greater diverter position value than each position of the first range of positions.

In some aspects, a valve includes a valve body, a fixed disc and a diverter. The valve body has an inlet port, a first outlet port and a second outlet port. The fixed disc is disposed in and fixed relative to the valve body. In addition, the diverter is rotatably disposed in the valve body. The diverter includes a movable disc that is parallel to the fixed disc and configured to rotate relative to the fixed disc about a rotational axis. The diverter cooperates with the fixed disc to control fluid flow from the inlet port to at least one of the first outlet port and the second outlet port in such a way that fluid flows through the first outlet port according to a first flowrate versus diverter position curve having a first curve portion and a second curve portion that adjoins the first curve portion. The first curve portion has a first linear slope. The second curve portion has a second linear slope. The second linear slope has an absolute value that is greater than the absolute value of first linear slope. In addition, fluid flows through the second outlet port according to a second flowrate versus diverter position curve, and the second flowrate versus diverter position curve is a mirror image of the first flowrate versus diverter position curve relative to a predetermined flowrate.

In some embodiments, the predetermined flowrate intersects the second curve portion of the first flowrate versus diverter position curve.

In some embodiments, the second curve portion is non-overlapping with the first curve portion. The fluid flow through the first outlet port is such that the flow rate for each diverter position of the second curve portion is less than the flow rate for each diverter position of the first curve portion. In addition, the fluid flow through the second outlet port is such that the flow rate for each diverter position of the second curve portion is greater than the flow rate for each diverter position of the first curve portion.

In some embodiments, the second curve portion of the first flowrate versus diverter position curve intersects the second curve portion of the second flowrate versus diverter position curve.

In some embodiments, the second curve portion of the first flowrate versus diverter position curve intersects the second curve portion of the second flowrate versus diverter position curve at a diverter position in a range of 85 percent to 95 percent of the complete range of diverter positions.

In some embodiments, the predetermined flow rate is in a range of 8 (liters/min) to 12 (liters/min).

In some embodiments, the first flowrate versus diverter position curve has a maximum flowrate for a diverter position in a range of 0 percent to 10 percent of the complete range of diverter positions.

In some embodiments, the valve body includes a seat and a cover. The seat extends with in a plane and includes a periphery that is surrounded by an upright rim, and the cover includes a cylindrical sidewall and a cap portion that closes one end of the sidewall. The seat and the cover cooperate in a fluid tight manner to define a valve chamber that is configured to receive the diverter and is in fluid communication with the inlet port, the first outlet port and the second outlet port.

In some embodiments, the inlet port, the first outlet port and the second outlet port are each formed in the seat.

In some embodiments, the diverter comprises a driver and the movable disc. The movable disc is disposed on a seat-facing surface of the driver and configured to be driven to rotate by the driver.

In some embodiments, the diverter comprises a driver and the movable disc. The movable disc is compressed between a seat-facing surface of the driver and a cap portion-facing surface of the fixed disc. The movable disc is driven to rotate by the driver.

In some embodiments, the driver has a disc-shaped foot that is disposed in the valve chamber and a stem that protrudes from a cap portion-facing surface of the foot. The stem is configured to extend through an opening in the cap portion and be mechanically connected to an actuator. The stem has a centerline that coincides with the rotational axis. In addition, the diverter is configured to control fluid flow through the valve body based on a rotational orientation of the driver relative to the valve body.

In some embodiments, the foot comprises a plurality of foot through openings.

In some embodiments, a cap-portion-facing surface of the foot has a protrusion that is configured to engage with a stop element of the cover to limit an extent of rotation of the driver relative to the valve body.

In some embodiments, the fixed disc is supported on, and fixed relative to, the seat, a sealing element is disposed between the fixed disc and the seat, the sealing element provides a fluid tight seal between the fixed disc and the seat, and a cap portion-facing surface of the fixed disc faces and abuts a seat-facing surface of the diverter.

In some aspects, a valve includes a valve body, a fixed disc and a diverter. The valve body includes a first end, a second end, and a cylindrical sidewall that extends between the first end and the second end. The first end, the second end and the sidewall together enclose a valve chamber. The valve body also includes an inlet port that communicates with the valve chamber, a first outlet port that communicates with the valve chamber, and a second outlet port that communicates with the valve chamber. The fixed disc is fixed relative to the valve body and segregates the valve chamber into a first chamber portion and a second chamber portion. The fixed disc includes fixed disc openings. The diverter is rotatably disposed in the first chamber portion. The diverter includes a movable disc that abuts the fixed disc and rotates relative to the fixed disc. The movable disc includes a movable disc opening. The fixed disc openings and the movable disc opening are configured so that the valve controls fluid flow through the valve body in a predetermined way. In particular, fluid flows through the first outlet port according to a first flowrate versus diverter position curve. The first flowrate versus diverter position curve has a first curve portion and a second curve portion that adjoins the first curve portion. The first curve portion has a first linear slope, the second curve portion has a second linear slope, and the absolute value of the second linear slope is greater than the absolute value of the first linear slope. In addition, fluid flows through the second outlet port according to a second flowrate versus diverter position curve, and the second flowrate versus diverter position curve is a mirror image of the first flowrate versus diverter position curve relative to a predetermined flowrate.

In some embodiments, each of the inlet port, the first outlet port and the second outlet port communicate with the second chamber.

### BRIEF DESCRIPTION OF THE FIGURES

FIG. 1 is a perspective view of a thermal management module including multiple multi-port rotary disc valves.

FIG. 2 is a perspective cross-sectional view of the thermal management module as seen along a line that bisects one of the rotary disc valves.

FIG. 3 is a perspective cross-sectional view of the rotary disc valve isolated from the thermal management module.

FIG. 4 is a top perspective view of a portion of the valve body showing the valve seat.

FIG. 5 is a top perspective view of a cover of the valve body.

FIG. 6 is a bottom perspective view of a cover of the valve body.

FIG. 7 is a top perspective view of a stacked arrangement of valve internal components including the diverter including the driver and the movable disc, the fixed disc and the sealing element.

FIG. 8 is a cross-sectional view of the stacked arrangement of valve internal components as seen along line 8-8 of FIG. 7.

FIG. 9 is a top perspective and exploded view of the stacked arrangement of valve internal components.

FIG. 10 is a bottom perspective and exploded view of the stacked arrangement of valve internal components.

FIG. 11 is top plan view of the fixed disc, the three regions of the disc shown in broken lines.

FIG. 12 is graph illustrating the flowrate (liters/minute) versus diverter position (percentage) for each of the two fluid outlet ports of the rotary valve.

FIG. 13 is a bottom plan view of a portion of the valve showing the relative positions of the sealing element and fixed disc with respect to the diverter and cover for a diverter position of 0 percent.

FIG. 14 is a bottom plan view of a portion of the valve showing the relative positions of the sealing element with respect to the diverter and cover for a diverter position of 0 percent.

FIG. 15 is a bottom plan view of a portion of the valve showing the relative positions of the diverter and cover for a diverter position of 0 percent.

FIG. 16 is a bottom plan view of a portion of the valve showing the relative positions of the sealing element and fixed disc with respect to the diverter and cover for a diverter position of 50 percent.

FIG. 17 is a bottom plan view of a portion of the valve showing the relative positions of the sealing element with respect to the diverter and cover for a diverter position of 50 percent.

FIG. 18 is a bottom plan view of a portion of the valve showing the relative positions of the diverter and cover for a diverter position of 50 percent.

FIG. 19 is a bottom plan view of a portion of the valve showing the relative positions of the sealing element and fixed disc with respect to the diverter and cover for a diverter position of 100 percent.

FIG. 20 is a bottom plan view of a portion of the valve showing the relative positions of the sealing element with respect to the diverter and cover for a diverter position of 100 percent.

FIG. 21 is a bottom plan view of a portion of the valve showing the relative positions of the diverter and cover for a diverter position of 100 percent.

FIG. 22 is a perspective view of an alternative embodiment diverter.

FIG. 23 is a cross-sectional view of the diverter of FIG. 22 as seen along line 23-23 of FIG. 22.

FIG. 24 is a top perspective and exploded view of the diverter of FIG. 22.

FIG. 25 is a bottom perspective view of the diverter of FIG. 22.

FIG. 26 is a bottom plan view of the diverter driver of the diverter of FIG. 22.

### DETAILED DESCRIPTION

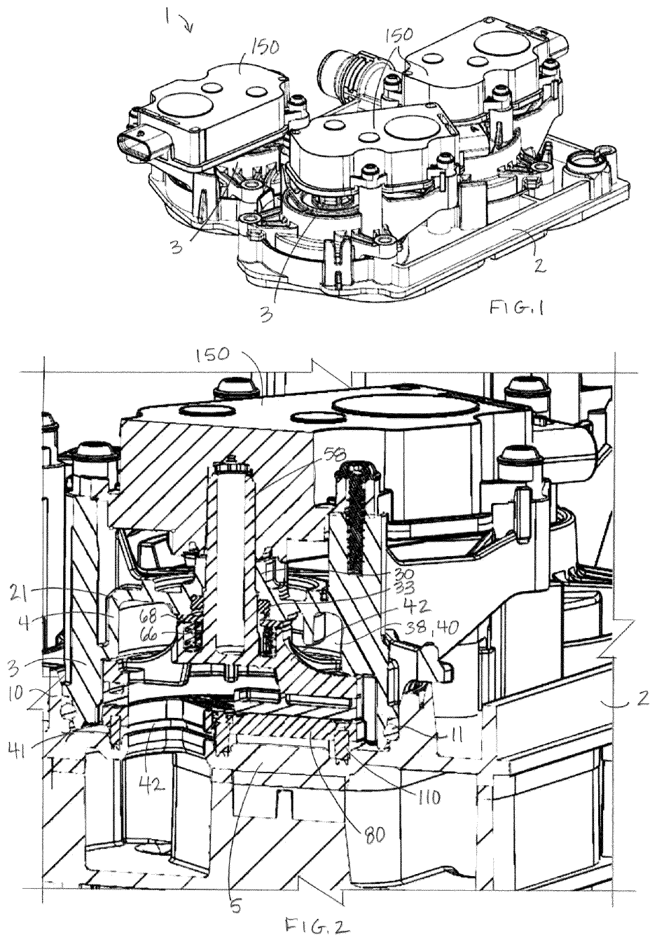

Referring to FIGS. 1-3, a thermal management module 1 that incorporates a coolant control portion of a thermal management system for an electric vehicle may include a disc-type rotary fluid valve 3 that can be used by the vehicle thermal management system to direct coolant, for example, to cool a drive motor, a charge air heat exchanger, a battery, power electronics modules, the vehicle passenger cabin and/or other vehicle components or systems that require temperature control. The module 1 may also include, for example, one or more circulation pumps, a fluid reservoir, additional fluid valves, a coolant control system controller, sensors, heat exchangers, etc. The rotary disc valve 3 is partially incorporated into a housing 2 of the module 1, which may include internal passageways that permit fluid communication between the various components of the system included in the module 1. The rotary disc valve 3 includes features that permit output of fluid having specific flow characteristics from one or more outlet ports 13, 14, as will be described in detail below.

The rotary disc valve 3 includes a valve body 4 and fluid controlling components 41 that are disposed in the valve body 4. The fluid controlling components 41 include a diverter 42 having a movable disc 43, the diverter 42 being rotatable relative to the valve body 4 about a rotational axis 61. The fluid controlling components 41 also include a fixed disc 80 and a sealing element 110. The fluid controlling components 41 will be described below.

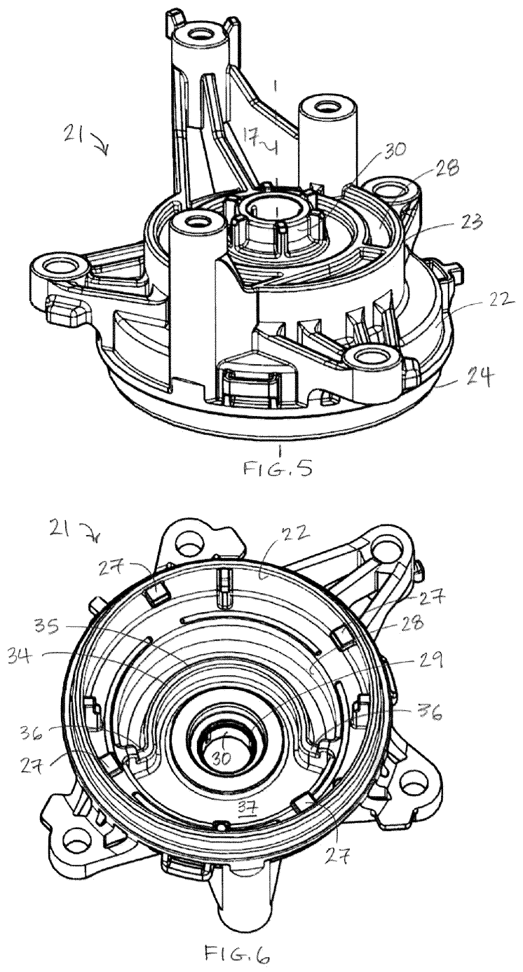

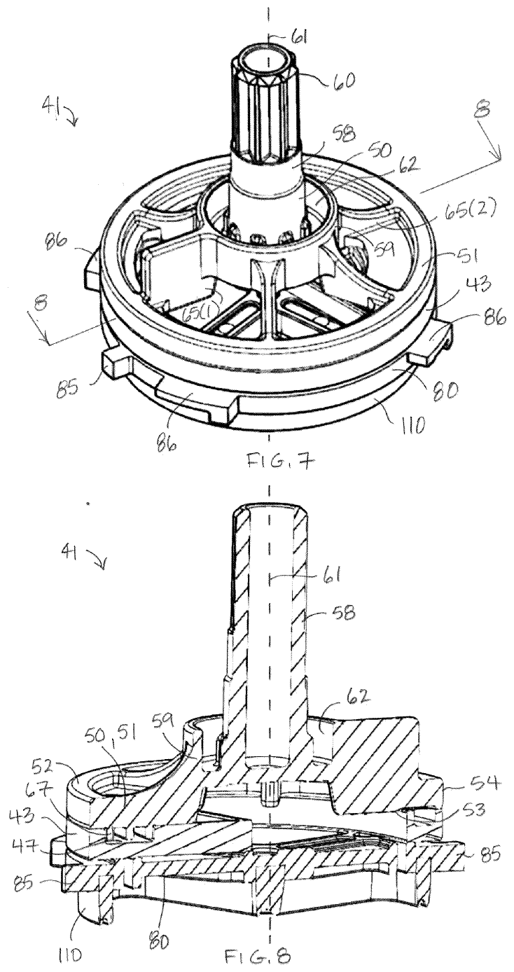

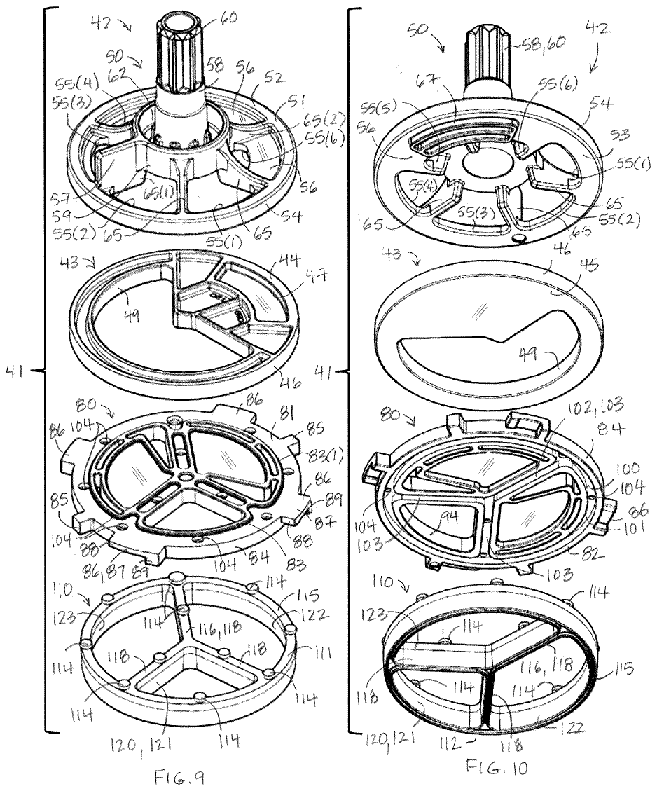

Referring to FIGS. 2-4, the valve body 4 has a valve seat 5 and a cover 21 that cooperates with the valve seat 5 to provide a closed container. The valve seat 5 extends within a plane P that is perpendicular to the rotational axis 61 and includes a circular periphery that is surrounded by an upright rim 10. In the illustrated embodiment, the valve seat 5 and rim 10 are formed integrally with, and are defined by a portion of, the module housing 2. In other embodiments, the valve seat 5 and the rim 10 are formed separately from the module housing 2 and are configured to be plugged into the module housing 2. In still other embodiments, the valve seat 5 and the rim 10 are formed separately from the module housing 2 and may be used independently of the module 2.

The rim 10 is concentric with the rotational axis 61 and encircles the valve ports 12, 13, 14 which open through the valve seat 5. In the illustrated embodiment, the rotary disc valve 3 includes a single inlet port 12 and two outlet ports 13, 14. The valve ports 12, 13, 14 are sector shaped, and the sum of the arc lengths of the valve ports 12, 13, 14 is approximately 360 degrees whereby the valve ports delineate a circular valve opening area 6 that is centered on the rotational axis 61. The areas of the outlet ports 13, 14 are equal, and the area of the inlet port 12 is less than that of either outlet port 13, 14. For example, in some embodiments, the inlet port 12 may have an arc length of 60 degrees and the outlet ports 13, 14 may each have an arc length of 150 degrees. It is understood that the arc lengths of the valve ports 12, 13, 14 depend on the requirements of the specific application, and thus may vary from this example.

The valve opening area 6 is segregated into the inlet and outlet ports 12, 13, 14 by three radially-extending seat lands 7 that intersect at the rotational axis 61 and have the appearance of wheel spokes. As used herein, the term “radial” refers to a direction perpendicular to and intersecting with the rotational axis 61. A seat groove 8 is provided in the valve seat 5 that surrounds the valve opening area 6 and also extends along the cap portion-facing surface of each of the seat lands 7. The seat groove 8 is shaped and dimensioned to receive the sealing element 110, which is described in detail below.

An annular gap 15 exists in the valve seat 5 between the seat groove 8 and the rim 10. The valve seat 5 includes two pairs of locating protrusions that are disposed in the gap 15. The pairs are disposed on diametrically opposed sides of the valve port opening area 6. Each pair of locating protrusions includes two, closely spaced and upright posts 16. The spacing between the posts 16 of a given pair is dimensioned to receive a bar 85 that protrudes from a peripheral surface 84 of the fixed disc 80 in a locational clearance fit, whereby the fixed disc 80 is prevented from rotating relative to the valve seat 5.

The valve seat 5 includes guide rails 18 that are disposed in the gap 15 on diametrically opposed sides of the valve port opening area 6 and are spaced apart from the posts 16. Each guide rail 18 is an upright structure that is elongated in a circumferential direction. In use, the inner surface 19 of each guide rail 18 faces the peripheral surfaces of the fixed disc 80 and sealing element 110, whereby the guide rails 18 maintain axial alignment of these structures. The cover-facing end 20 of each guide rail 18 is beveled in order to facilitate assembly of the fluid controlling elements with the valve body 4.

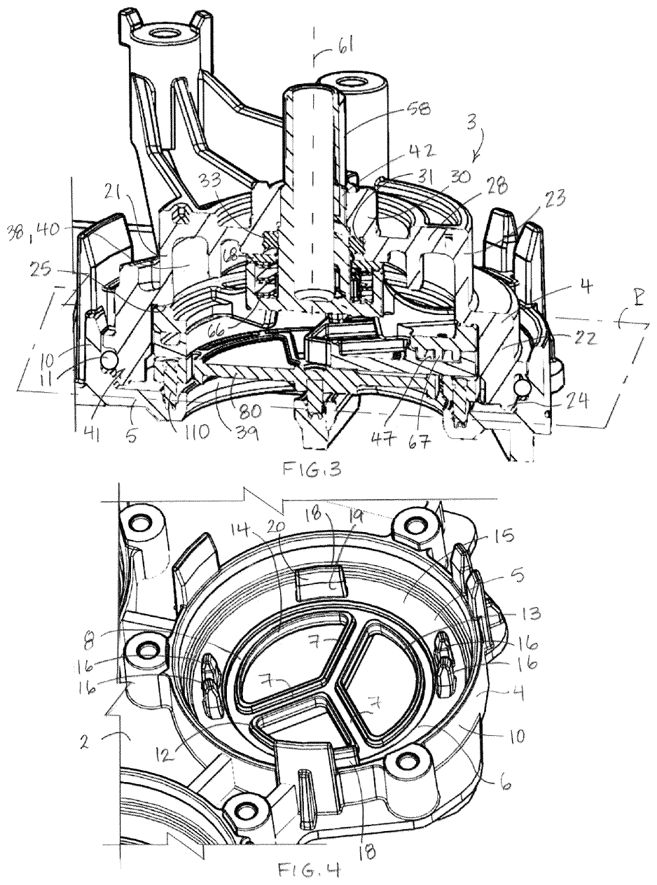

Referring to FIGS. 3 and 5-6, the cover 21 includes a cylindrical sidewall 22 and a cap portion 28 that closes a first end 23 of the sidewall 22. A centerline 17 of the sidewall 22 coincides with the rotational axis 61. The end of the sidewall 22 opposite the cap portion 28 (e.g., the sidewall second end 24) is open and surrounds the rim 10. An annular cover seal 11 such as an O-ring is disposed between the sidewall second end 24 and the rim 10 to provide a fluid tight seal between the cover 21 and the valve seat 5. The sidewall 22 has a non-uniform diameter, whereby the cap portion 28 of the cover 21 has a smaller diameter than a diameter of the sidewall second end 24. In addition, an inner surface of the sidewall 22 defines a valve seat-facing shoulder 25 at the transition between diameters. The cover 21 includes beams 27 that protrude inward from the sidewall 22 toward the centerline 17. The beams 27 have a rectangular cross-sectional shape and are configured to be engaged by a catch 86 of the fixed disc 80, as discussed in detail below. In the illustrated embodiment, the cover 21 includes four beams 27, but a fewer or greater number of beams 27 can be employed as required by the specific application.

The cap portion 28 includes a central opening 29 that is centered on the sidewall centerline 17 and is dimensioned to receive a stem 58 of the diverter 42, as discussed below. A sleeve 30 that is integral with the cap portion 28 encircles the central opening 29 and protrudes outwardly from the cap portion 28. The sleeve 30 serves as a plain bearing that supports the stem 58 during rotation.

The cap portion 28 includes an annular cap groove 31 that extends about the inner circumference of the sleeve 30. The cap groove 31 opens facing the centerline 17 and is shaped and dimensioned to receive a stem seal 33. The stem seal 33 provides a liquid tight fluid seal between the cover 21 and the stem 58. The stem seal 33 is annular and may be formed of an elastomer that is compatible with automotive coolant, such as ethylene propylene diene monomer (EPDM). In the illustrated embodiment, the stem seal 33 is an O-ring having an “X” cross-sectional shape. In other embodiments, the stem seal 33 may have other cross-sectional shapes, such as, but not limited to, rectangular, oval or “I” shapes.

The seat-facing surface of the cap portion 28 includes an axially protruding rib 34. The rib 34 includes an arcuate circumferential portion 35 that partially surrounds the central opening 29. In addition, the rib 34 includes radial portions 36 that extend linearly in a radial direction between each of the opposed ends of the circumferential portion 35 and the sidewall 22. The radial portions 36 serve as stops that govern the extent of rotation of the diverter 42 with respect to the valve body 4, as discussed in more detail below. The rib-free region between the radial portions 36 defines a cap channel 37 that receives a bumper arm 57 of the diverter 42 in a loose running clearance fit. The length of the cap channel 37 corresponds to the distance between the radial portions 36 and is determined by the requirements of the specific application. In the illustrated embodiment, the distance between the radial portions 36 in the rib-free region corresponds to an arc length of 150 degrees.

The valve seat 5 and the cover 21 cooperate in a fluid tight manner to define a valve chamber 38 that is configured to receive the diverter 42, a wave spring 66 and a thrust washer 68. In addition, the fixed disc 80 and the sealing element 110 are also disposed in the valve chamber 38 in an axially stacked arrangement with the diverter 42. The valve chamber 38 is in fluid communication with the valve ports 12, 13, 14 which are formed in the valve seat 5 and therefore permit fluid flow to enter and exit the valve body 4 in the axial direction.

Referring to FIGS. 3 and 7-11, the diverter 42 includes a driver 50 and a movable disc 43 that is engaged with a foot 51 of the driver 50 in such a way that the movable disc 43 rotates in concert with the driver 50 about the rotational axis 61.

The driver 50 includes the foot 51 which is generally disc-shaped. In addition, the driver 50 includes a stem 58 that protrudes integrally from a cap portion-facing surface 52 of the foot 51. The foot 51 and the stem 58 are each concentric with the rotational axis 61.

The first end or base 59 of the stem 58 has an enlarged diameter relative to a midportion and a second end 60 of the stem 58. The stem 58 has an axial dimension that is sufficient to protrude through the cap portion central opening 29. The stem second end 60 is configured to be connected to a valve actuator 150. For example, in the illustrated embodiment, the outer surface of the stem second end 60 may include flats, splines (shown) or other features that permit engagement with an output structure of the valve actuator 150. Upon actuation, the diverter 42 rotates relative to the valve body 4 about the rotational axis 61, and the rotational orientation of the diverter 42 relative to the valve body 4 is set and/or changed via the valve actuator 150.

The thrust washer 68 encircles the stem 58 and is disposed between the stem base 59 and the seat-facing surface of the cap portion 28.

The rotary valve 3 includes the spring 66 that is disposed between the cover 21 and the diverter 42 and surrounds the diverter stem 58. Although in the illustrated embodiment, the spring 66 is a wave spring, other springs (i.e., a compression spring) or elastic members may be substituted. One end of the spring 66 abuts the thrust washer 68 which in turn abuts the cover 21. An opposed end of the spring 66 is received in an annular foot groove 62 that encircles the stem 58, whereby the opposed end of the spring 66 abuts the base 59 of the diverter stem 58. Within the assembly, the spring 66 is under compression, whereby the spring 66 biases the diverter 42 toward the valve body base seat 5 and provides a sealing force to the fluid controlling components 41 of the rotary valve 3. In particular, the spring 66 pushes the diverter 42 toward the valve body seat 5, ensuring a fluid tight seal between the movable disc 43 and the fixed disc 80, and between the fixed disc 80 and the valve seat 5 via the relatively soft and resilient sealing element 110. In addition, the sealing element 110 permits the internal components to adapt to the changes in dimension caused by changes in temperature and due to wear of the diverter 42 and discs 43, 80.

The driver foot 51 includes the cap portion-facing surface 52 and a seat-facing surface 53 that is opposite the cap portion-facing surface 52. The driver foot 51 includes a peripheral surface 54 that faces the cover sidewall 22. The axial dimension of the foot peripheral surface 54 is less than an axial dimension of the stem base 59.

The driver foot 51 includes foot openings 55 that are disposed between the stem base 59 and the foot peripheral surface 54. The foot openings 55 are arranged side-by-side so as to surround the stem 58. The foot openings 55 are through-openings that extend from the cap portion-facing surface 52 to the seat-facing surface 53. The portions of the driver foot 51 between adjacent foot openings 55 are referred to hereafter as foot lands 65. On the foot cap portion-facing surface 52, each of the foot lands 65 protrudes toward the cap portion 28 to provide a curved buttress that extends from a minimum axial dimension at the foot peripheral surface 54 to a maximum axial dimension at the stem base 59.

In the illustrated embodiment, there are six foot openings 55. Each of the foot openings 55 is sector shaped and each foot opening 55 has the same arc length, e.g., an arc length of 60 degrees. The first through fourth foot openings 55(1), 55(2), 55(3), 55(4) have a radial dimension that is greater that the radial dimension of the fifth and sixth foot openings 55(5), 55(6). The fifth and sixth foot openings 55(5), 55(6) are disposed closer to the stem base 59 than to the foot peripheral surface 54, and a web 56 (e.g., a thin plate) extends between each of the fifth and sixth foot openings 55(5), 55(6) and the foot peripheral surface 54. Each web 56 extends circumferentially between, and is supported by, the foot lands 65 that are adjacent to the fifth and sixth foot openings 55(5), 55(6).

The driver foot 51 includes a bumper arm 57 that protrudes axially from one of the foot lands 65 toward the cap portion 28. In the illustrated embodiment, the foot land 65(1) from which the bumper arm 57 protrudes is disposed on diametrically opposed portions of the foot cap portion-facing surface 52 relative to the foot land 65(2) that extends between the two adjacent webs 56.

The bumper arm 57 has a shape and an axial dimension that permits the bumper arm to protrude into the cap channel 37. When the diverter 42 is viewed in a side view, the bumper arm 57 has a rectangular profile, but is not limited to this configuration. For certain angular orientations of the diverter 42 relative to the valve seat 5 and valve housing 2, the bumper arm 57 abuts a respective rib radial portion 36. Thus, the diverter 42 may be actuated by an actuator 150 to rotate freely about the rotational axis 61 with respect to the valve body 4 with the bumper arm 57 moving within the cap channel 37 to an extent permitted by the length of the cap channel 37. The rib radial portions 36 serve as stops to the movement of the bumper arm 57 whereby the amount of rotation of the diverter 42 relative to the valve body 4 is limited.

Although the seat-facing surface 53 of the foot 51 is generally flat (e.g., planar), the foot 51 includes a protruding key element 67 that is configured to form a mechanical connection with the movable disc 43 and to drive the moveable disc 43 to rotate in concert with the driver 50.

The key element 67 protrudes from the foot seat-facing surface 53 in an axial direction toward the valve seat 5. The key element 67 is disposed on a diametrically opposed portion of the foot seat-facing surface 53 relative to the foot land 65(1) that includes the bumper arm 57. The key element 67 has a curved shape that corresponds to the curve defined by the foot peripheral surface 54. In the illustrated embodiment, the key element 67 is shaped and dimensioned to be received in a recess 47 provided in the cap portion-facing surface 44 of the movable disc 43. The key element 67 is an arcuate protrusion that is disposed between the fifth and sixth foot openings 55(5), 55(6) and the foot peripheral surface 54. The key element 67 extends circumferentially along the web 56 of the seat-facing surface 53 of the foot 51. The key element 67 has a radial dimension that is greater than fifty percent of the radial distance between the fifth and sixth foot openings 55(5), 55(6) and the foot peripheral surface 54. The axial dimension of the key element 67 is less than an axial dimension of the movable disc 43.

When the driver 50 is assembled with the movable disc 43, the key element 67 is received in and engages with the recess 47 of the movable disc 43. As a result, the torque supplied by the actuator 150 to the driver 50 is transferred to the movable disc 43, whereby the movable disc 43 rotates in concert with the driver 50.

In the illustrated embodiment, the driver 50 of the diverter 42 is formed of a plastic such as a glass fiber reinforced Polyphenylene Sulfide (PPS), for example Polyphenylene Sulfide with 40 percent glass (PPS GF40). Other suitable materials include, but are not limited to, Polypropylene (PP) or Polyamide (PA). The material used for a specific application is selected based on the requirements of the application.

The movable disc 43 is a rigid cylindrical plate having an axial dimension that is much less than its diameter (e.g., the movable disc 43 is disc shaped). The movable disc 43 includes a cap portion-facing surface 44 that faces toward the seat-facing surface 53 of the driver foot 51, and a seat-facing surface 45 that faces toward the valve seat 5. The movable disc 43 includes a movable disc peripheral surface 46 that extends from the cap portion-facing surface 45 to the seat-facing surface 45. The seat-facing surface 45 of the movable disc 43 is planar (e.g., flat or level and smooth, without raised areas, protrusions, recesses, indentations or surface features or irregularities). The cap-portion-facing surface 44 of the movable disc 43 includes features that permit a mechanical engagement between the movable disc 43 and the foot 51 of the diverter driver 50. In particular, the cap-portion-facing surface 44 of the movable disc 43 includes the recess 47 that is located, shaped and dimensioned to receive the key element 67 of the foot 51 in a locational clearance fit.

While the cap portion-facing surface 44 of the movable disc 43 faces, and engages with, the seat-facing surface 53 of the driver foot 51, the movable disc seat-facing surface 45 faces, and directly contacts, a corresponding surface 81 of the fixed disc 80.

The movable disc 43 includes a single movable disc opening 49 that is disposed between a center of the movable disc 43 and the movable disc peripheral surface 46. The movable disc opening 49 is disposed at a location that is diametrically opposed to the first recess 47. The movable disc opening 49 is a through-opening that extends from the cap portion-facing surface 44 to the seat-facing surface 45. The movable disc opening 49 has a generally sector shaped profile as seen when the movable disc 43 is viewed in an axial direction. The movable disc opening 49 extends radially from a location adjacent the disc center to a location adjacent the movable disc peripheral surface 46. In addition, the movable disc opening 49 extends along an arc length of about 210 degrees.

In the illustrated embodiment, the movable disc 43 is formed of a plastic such as Polyketone (PK), Polyoxymethylene (POM), or other suitable material. The material used for a specific application is selected based on the requirements of the application.

The fixed disc 80 is disposed in the valve chamber 38 in an axially stacked arrangement of components that includes the diverter 42, the fixed disc 80, the sealing element 110 and the valve seat 5. The fixed disc 80 is disposed in the stack between the movable disc 43 of the diverter 42 and the sealing element 110. The fixed disc 80 segregates the valve chamber 38 into a first chamber portion 39 that includes the valve ports 12, 13, 14 and a second chamber portion 40 that includes the diverter 42.

The fixed disc 80 is a rigid cylindrical plate having an axial dimension that is much less than its diameter (e.g., the fixed disc 80 is disc shaped). The fixed disc 80 includes a cap portion-facing surface 81 that faces toward and abuts the movable disc 43 of the diverter 42, and a seat-facing surface 82 that faces toward the valve seat 5 and abuts the sealing element 110. The fixed disc 80 includes a fixed disc peripheral surface 84 that extends between the cap portion-facing surface 81 and seat-facing surface 82 thereof.

The fixed disc 80 includes features that angularly and axially position the fixed disc 80 relative to the valve body 4. In the illustrated embodiment, the fixed disc 80 includes bars 85 that protrude outward from the fixed disc peripheral surface 84. In the illustrated embodiment, the fixed disc 80 includes a bar 85 that is disposed on each of diametrically opposed sides of the fixed disc 80. The two bars 85 extend along a common diameter. In addition, the bars 85 are shaped and dimensioned to be received in the gap between the posts 16 of each pair of locating protrusions of the valve body 4. In particular, each bar 85 is received in the respective gap in a locational clearance fit. As a result, the fixed disc 80 is prevented from rotating relative to the valve body 4.

In addition to the bars 85, the fixed disc 80 includes catches 86 that protrude outward from the fixed disc peripheral surface 84. In the illustrated embodiment, the fixed disc 80 includes four catches 86 that are spaced apart along a circumference of the fixed disc peripheral surface 84. Each catch 86 includes a plate portion 87 that protrudes in parallel to the fixed disc base-facing surface 82. In addition, each catch 86 includes a leading edge lip 88 and a trailing edge lip 89. The leading and trailing edge lips 88, 89 extend toward the valve seat 4 so that each catch 86 has a general C shape. An axial dimension of the leading edge lip 88 is less than an axial dimension of the trailing edge lip 89. The circumferential spacing between the leading edge lip 88 and the trailing edge lip 89 corresponds to or is slightly greater than the circumferential dimension of the sidewall beam 27. In use, each sidewall beam 27 is engaged with, and partially enclosed by, a respective one of the catches 86. In particular, for each catch 86, the corresponding beam 27 underlies the plate portion 87 and is disposed between the leading edge and trailing edge lips 88, 89. As a result, the fixed disc 80 is prevented from axial motion (e.g., sudden disassembly) relative to the valve body 4 while a subassembly that includes the cover 21, the spring 66, the thrust washer 68, cover seal 11, sealing element 110, diverter 42 and fixed disc 80 is transported to the module 1 for final assembly. When the sub-assembly is attached to the valve seat, the fixed disc 80 bars 85 contact the base of each gap 15 between the pairs of bars 16, axially locating the fixed disc 80 within the rotary valve 3. As the cover 21 is attached to the module 1, the cover 21 moves axially relative to the fixed disc 80 so that the beams 27 move away from the catches 86, until the cover 21 seats completely. The cover 21 is then fixed to the module bosses using fasteners such as screws.

The fixed disc 80 has three sector shaped regions 91, 92, 93 (FIG. 11). The first region 91 overlies the inlet port 12 and has an arc length that corresponds to the arc length of the inlet port 12. In addition, the second and third regions 92, 93 overlie the first and second outlet ports 13, 14, respectively. The second and third regions 92, 93 have an arc length that corresponds to the arc lengths of the first and second outlet ports 13, 14, respectively. Thus, in the illustrated embodiment, the first region 91 has an arc length of 60 degrees, the second region 92 has an arc length of 150 degrees, and the third region 93 has an arc length of 150 degrees.

The fixed disc 80 includes a first fixed disc opening 94 that is formed in the first region 91. The first fixed disc opening 94 has a shape and dimensions generally corresponding to those of the inlet port 12. In particular, the first fixed disc opening 94 is a through-opening that extends from the fixed disc cap portion-facing surface 81 to the fixed disc seat-facing surface 82. The first fixed disc opening 94 has a sector shaped profile when the fixed disc 80 is viewed in an axial direction. The first fixed disc opening 94 extends radially from a location adjacent the disc center to a location adjacent the fixed disc peripheral surface 84. In the illustrated embodiment, the first fixed disc opening 94 has an arc length of 60 degrees.

The second and third regions 92, 93 are substantially intact. However, each of the second and third regions 92, 93 includes an irregularly-shaped fixed-disc opening. Specifically, the second region 92 includes the second fixed disc opening 95 and the third region 93 includes the third fixed disc opening 96. The second and third fixed disc openings 95, 96 are through openings that extend from the fixed disc cap portion-facing surface 81 to the fixed disc seat-facing surface 82. The second fixed disc opening 95 has the same shape and dimensions as the third fixed disc opening 96. Each of the second and third fixed disc openings 95, 96 has a small area as compared to the area of the respective region 92, 93.

Each of the second and third fixed disc openings 95, 96 has a first opening portion 98 and a second opening portion 99. The first opening portion 98 defines a sector shaped opening, the sector having an arc length of about 20 percent of the total arc length of the region. In the illustrated embodiment, the arc length of the first opening portion 98 is 30 degrees. A radially-extending edge of the first opening portion 98 of the second fixed disc opening 95 generally coincides with a radial boundary between the first and second regions 91, 92. The second opening portion 99 of the second fixed disc opening 95 defines a narrow, curved slot that extends along a periphery of the second region 92 over an arc length of 120 degrees. The second opening portion 99 has a different shape and smaller opening area than the first opening portion 98, and may consist of a single continuous slot or may be a series of slots of smaller arc lengths. The second opening portion 99 of the second fixed disc opening 95 extends between the first opening portion 98 and the radial boundary between the second and third regions 92, 93.

The third fixed disc opening 96 is formed in the third region 93 and has the same shape and dimensions as the second fixed disc opening 95. In particular, the first opening portion 98 of the third fixed disc opening 96 defines a sector shaped opening. A radially-extending edge of the first opening portion 98 of the third fixed disc opening 96 generally coincides with a radial boundary between the second and third regions 92, 93. The second opening portion 99 of the third fixed disc opening 96 defines a narrow, curved slot that extends along a periphery of the third region 93 over an arc length of 120 degrees. The second opening portion 99 may consist of a single continuous slot or may be a series of slots of smaller arc lengths. The second opening portion 99 of the third fixed disc opening 96 extends between the first opening portion 98 and the radial boundary between the third and first regions 93, 91.

The cap portion-facing surface 81 of the fixed disc 80 includes a narrow, protruding curb 83 that extends along the profile of each of the first, second, and third fixed disc openings 94, 95, 96. The axial dimension of the curb 83 is small relative to the axial dimension of the fixed disc 80. The end face 83(1) of the curb 83 provides the surface that abuts, and forms a fluid-tight seal with, the seat-facing surface 45 of the movable disc 43.

The seat-facing surface 82 of the fixed disc 80 includes a shallow channel 100 that is shaped and dimensioned to receive a portion of the sealing element 110 therein. In the illustrated embodiment, the channel 100 has an annular portion 101 that encircles the first, second and third regions 91, 92, 93 and a central portion 102. The central portion 102 includes three lanes 103 that extend radially between a center of the fixed disc 80 and the annular portion 101. The three lanes 103 extend along lands disposed between the respective first, second, and third fixed disc openings 94, 95, 96.

The fixed disc 80 includes several channel openings 104 that are disposed in the channel 90. The channel openings 104 are through openings that extend from the fixed disc cap portion-facing surface 81 to floor of the channel 90. Each of the channel openings 104 has a small area as compared to the area of the fixed disc openings 94, 95, 96. Each of the channel openings 104 is shaped and dimensioned to receive a post 114 that protrudes from the cap portion-facing surface of the sealing element 110. The number of channel openings 104 is determined by the requirements of the specific application. In the illustrated embodiment, there are eight circumferentially-spaced channel openings 104 that are disposed in the channel annular portion 101, and a channel opening 104 is disposed in each of the lanes 103.

The sealing element 110 provides a fluid-tight seal between the fixed disc 80 and the valve seat 5. The sealing element 110 is shaped and dimensioned to correspond to the shape and dimensions of the seat groove 8 of the valve seat 5. The sealing element 110 is circular elastic member having an axial dimension that is much less than its diameter (e.g., the sealing element 110 is generally disc shaped). The sealing element 110 includes a cap portion-facing surface 111 that faces toward the fixed disc 80 and is received in the channel 100. The sealing element 110 includes a seat-facing surface 112 that faces toward the valve seat 5 and is received in the seat groove 8. The sealing element 110 includes a sealing element peripheral surface 113 that extends between the cap portion-facing surface 111 and seat-facing surface 112 thereof.

In the illustrated embodiment, the sealing element 110 has an annular portion 115 that encircles the valve opening area 6 including the inlet port 12 and the first and second outlet ports 13, 14. In addition, the sealing element 110 includes a central portion 116. The central portion 116 includes three struts 118 that extend radially between a center of the sealing element 110 and the annular portion 115. As a result, the sealing element 110 has the appearance of a spoked wheel when viewed in a direction parallel to the rotation axis 61. The three struts 118 are supported on the radially-extending valve seat lands 7 that are disposed between the inlet port 12 and the first and second outlet ports 13, 14.

The sealing element 110 has sealing element openings 120, which are defined between adjacent struts 118. The sealing element openings 120 are shaped, dimensioned and relatively spaced to accommodate the shape, dimensions and spacing of the inlet port 12 and first and second outlet ports 13, 14, as defined between the seat lands 7 of the valve seat 5. More particularly, the sealing element 110 includes a first sealing element opening 121 that is axially aligned with and has the same shape and dimensions as the inlet port 12. The sealing element 110 includes second and third sealing element openings 122, 123 that are axially aligned with, and have the same shape and dimensions as, the first and second outlet ports 13, 14. Like the valve ports 12, 13, 14, the sealing element openings are sector shaped. Like the seat lands 7, the sealing element struts 118 are not equidistantly spaced, whereby the respective sealing element openings 120 do not each have the same arc length. In the illustrated embodiment, the first sealing element opening 121 may have an arc length of 60 degrees and the second and third sealing element openings 122, 123 may each have an arc length of 150 degrees. It is understood that the arc lengths of the sealing element openings 120 depend on the requirements of the specific application, and thus may vary from this example.

The cap portion-facing surface 111 of the sealing element 110 includes protruding posts 114. Each post 114 is located, shaped and dimensioned to be received in a respective one of the channel openings 104 in a press fit. In the illustrated embodiment, there are eight circumferentially-spaced posts 114 disposed along the sealing element annular portion 115, and a post 114 is disposed along each of the struts 118. The engagement of the posts 114 with the channel openings 104 serves to prevent relative rotation of the sealing element 110 relative to the fixed disc 80 and to prevent relative axial movement between the sealing element 110 and the fixed disc 80.

In addition, the cap portion-facing surface 111 of the sealing element 110 faces toward, and directly contacts, the fixed disc seat-facing surface 82. More particularly, the sealing element 110 is partially received in the channel 100. The engagement between the surfaces of the sealing element 110 and facing surfaces of the channel 100 serves to prevent relative rotation of the sealing element 110 relative to the fixed disc 80.

Similarly, the seat-facing surface 112 of the sealing element 110 faces toward, and directly contacts, the valve seat 5. More particularly, the sealing element 110 is partially received in the seat grove 8. The engagement between the surfaces of the sealing element 110 and the facing surfaces of the seat groove 8 serves to prevent relative rotation of the sealing element 110 relative to the valve seat 5.

Thus, both the fixed disc 80 and the sealing element 110 are fixed relative to the valve seat 5.

The sealing element 110 has a greater elasticity than the fixed disc 80. In addition, the sealing element 110 is formed of an elastic material that is compatible with the fluid that flows through the rotary disc valve 3 and meets the requirements for operating temperature and durability. For example, when the rotary disc valve 3 is used to control fluid in a vehicle coolant system, the first elastic element 110 is formed of an elastomer that is compatible with automotive coolant, such as ethylene propylene diene monomer (EPDM).

The rotational orientation of the diverter 42 relative to the valve body 4 determines one or more fluid flow paths through corresponding ones of the inlet port 12 and the first and second outlet ports 13, 14, whereby the distribution of coolant fluid in the cooling system 1 is controlled.

In some embodiments, the diverter 42 cooperates with the fixed disc 80 to control fluid flow from the inlet port 12 to the first outlet port 13 and/or the second outlet port 14 in such a way that fluid exits the rotary valve 3 with a flowrate that is predetermined and based on the position (e.g., angular orientation) of the diverter 42 with respect to the valve body 4.

Referring to FIG. 12, in the illustrated embodiment, fluid flows through the first outlet port 13 according to a first flowrate versus diverter position curve 130 having a first curve portion 131 and a second curve portion 132 that adjoins, and is continuous with, the first curve portion 131. The first curve portion 131 is linear and has a first slope M1, the second curve portion 132 is substantially linear and has a second slope M2, and the second slope M2 has an absolute value that is greater than the absolute value of first slope M1. In addition, fluid flows through the second outlet port 14 according to a second flowrate versus diverter position curve 135. The second flowrate versus diverter position curve 135 has a first curve portion 136 and a second curve portion 137 that adjoins, and is continuous with, the first curve portion 136. The second flowrate versus diverter position curve 135 is a mirror image of the first flowrate versus diverter position curve 130 relative to a predetermined flowrate. In the illustrated embodiment, the predetermined flowrate is 10 liters/minute. The first curve portion 136 is linear and has a first slope M3 that is equal and opposite to the first slope M1 of the first flowrate versus diverter position curve 130. The second curve portion 132 is substantially linear and has a second slope M4 that is equal to and opposite the second slope M2 of the first flowrate versus diverter position curve 130. With respect to the second flowrate versus diverter position curve 135, the second slope M4 has an absolute value that is greater than the absolute value of first slope M3.

By controlling fluid flow through the rotary valve 3 in accordance with the first and second flowrate versus diverter position curves 131, 135, the rate of fluid flow through the valve body 4 can be adjusted with a first resolution for a diverter position in a first range of positions and with a second resolution for a diverter position in a second range of positions, and the second resolution is more coarse than the first resolution. For example, by controlling fluid to flow through the rotary valve 3 according to the curves 130, 135, fluid flow exiting the first and second outlet ports 13, 14 can be controlled so that fine control of vehicle cabin temperature for a first range of diverter positions relative to the valve body, and allows large changes in vehicle cabin temperature for a second range of diverter positions relative to the valve body 4.

To achieve the desired flow characteristics, the through openings of the moving and fixed discs 43, 80 have a specific shape and are movable relative to each other about the rotational axis 61. For example, in the illustrated embodiment, the movable disc 43 has a single, sector-shaped opening 49 that extends through an arc of 210 degrees. The movable disc 43 moves in concert with the driver 50 through a range of motion limited by movement of the bumper arm 57 within the cap channel 37 of the cover 21.

In addition, the fixed disc, which is stacked with the movable disc within the valve chamber, has the first fixed disk opening 94 that is axially aligned with the inlet port 12, the second fixed disc opening 95 that is axially aligned with the first outlet port 13 and the third fixed disc opening 96 that is axially aligned with the second outlet port 14. The first fixed disc opening 94 has a sector-shape and an arc length of 60 degrees. The second fixed disc opening 95 and the third fixed disc opening 96 have the same irregular shape and dimensions. In the illustrated embodiments, each of the second and third fixed disc openings 95, 96 has the first opening portion 98 of a sector shape and the second opening portion 99 of a narrow, circumferentially extending slot. In the illustrated embodiment, the arc length of the first opening portion 98 is 30 degrees, and the arc length of the second opening portion 99 is 120 degrees, whereby the second and third fixed disc openings 95, 96 have an overall arc length of 150 degrees.

The diverter 42 including the movable disc 43 is driven by the actuator 150 which is controlled by a controller (not shown) to rotate relative to the fixed disc 80 through a range of about 135 degrees.

Regardless of diverter position across the range of possible positions, the moveable disc opening 49 extends fully across the inlet port 12 so that the inlet port 12 is always fully open. In the illustrated embodiment, the range of possible positions is between 0 degrees and 135 degrees, inclusive.

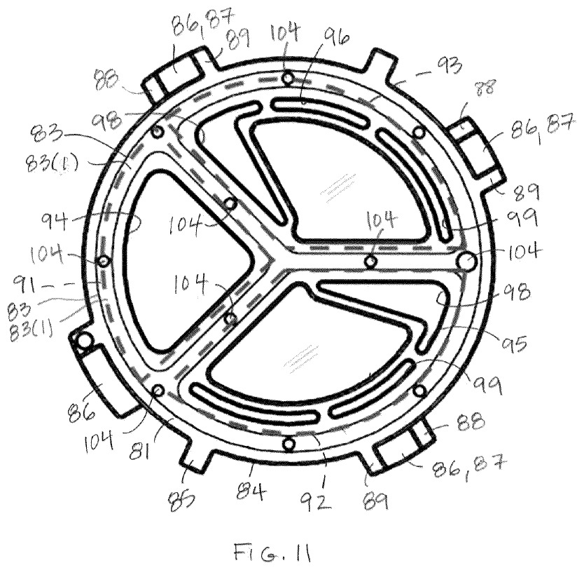

Referring to FIGS. 12-15, when the diverter 42 is at an initial position corresponding to the bumper arm 57 abutting one rib radial portion 36 of the cap portion 28, referred to here as “0 percent” position, the moveable disc opening 49 is fully axially aligned with the inlet port 12 and the first outlet port 13. The second outlet port 14 is completely closed.

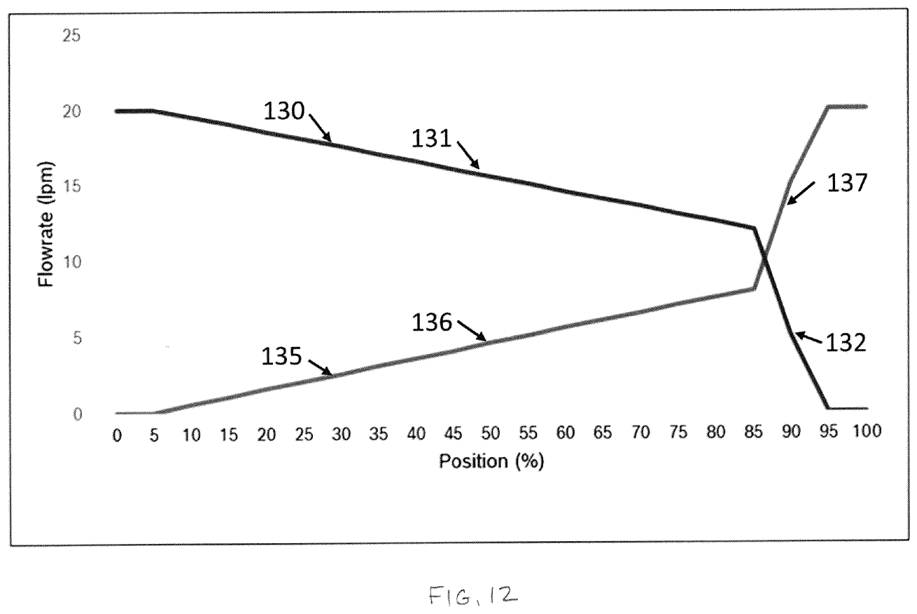

As the movable disc 43 rotates, the bumper arm 57 moves away from the one rib radial portion 36. The movable disc opening 49 gradually moves out of alignment with first outlet port 13 and toward alignment with the second outlet port 14. When the diverter 42 is in a “50 percent position”, the bumper arm 57 is midway between the one rib radial portion and the other rib radial portion. In this orientation, the movable disc opening 49 extends partially across the first outlet port 13, extends fully across the inlet port 12, and extends partially across the second outlet port 14, as shown in FIGS. 16-18.

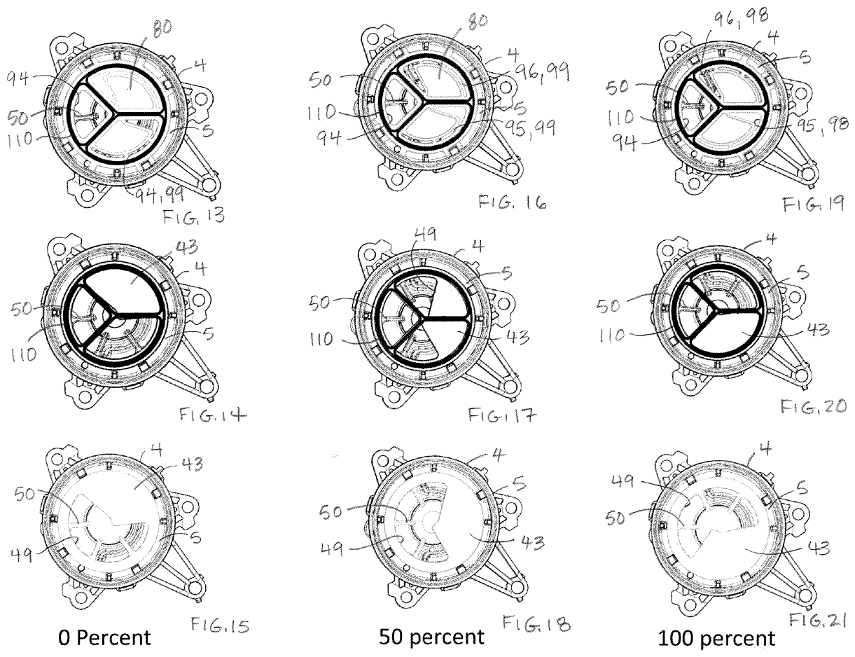

Referring to FIGS. 19-21, when the diverter 42 is at a final position corresponding to the bumper arm 57 abutting the other rib radial portion 36 of the cap portion 28, referred to here as “100 percent” position, the moveable disc opening 49 is fully axially aligned with the inlet port 12 and the second outlet port 14. The first outlet port 13 is completely closed.

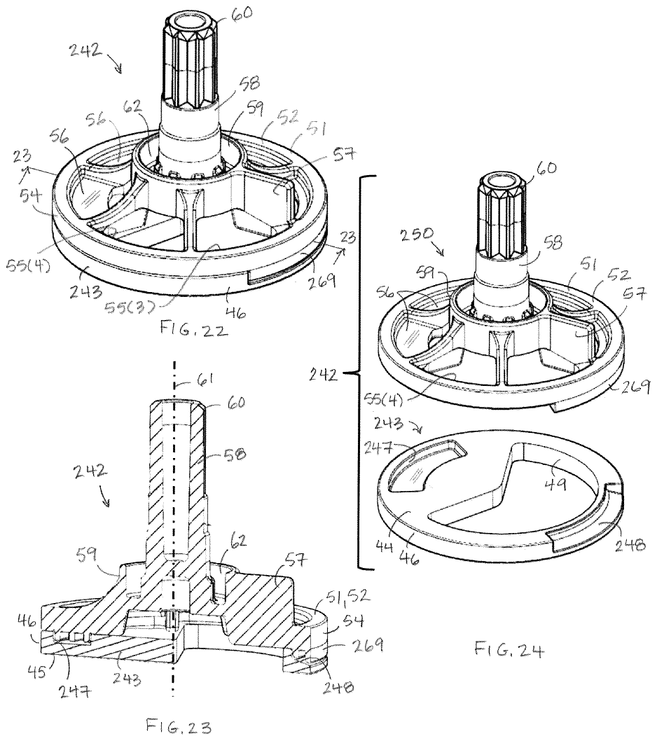

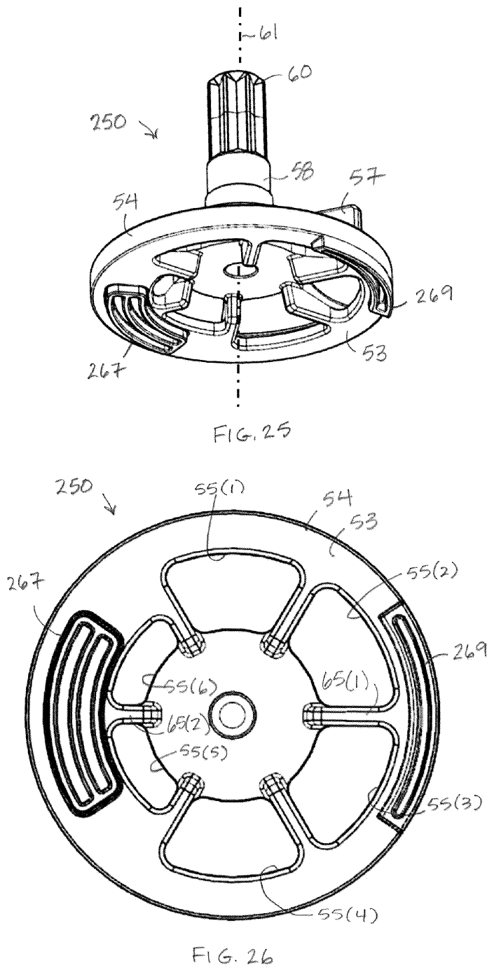

Referring to FIGS. 22-26, an alternative embodiment diverter 242 may be used in the rotary valve 3. The alternative embodiment diverter 242 is similar to the diverter 42 described above with respect to FIGS. 2-3 and 7-10, and common reference numbers are used to refer to common elements. The alternative embodiment diverter 242 differs from the diverter 42 with respect to the mechanical engagement between the diverter foot 251 and the movable disc 243.

As in the previous embodiment, the seat-facing surface 53 of the foot 251 is generally flat (e.g., planar). In the embodiment shown in FIGS. 22-26, the foot 251 includes a protruding first key element 267 and a protruding second key element 269 that are configured to form a mechanical connection with the movable disc 243 and to drive the moveable disc 243 to rotate in concert with the driver 250.

The first key element 267 and second key element 269 protrude from the foot seat-facing surface 53 in an axial direction toward the valve seat 5. The first key element 267 is disposed on a diametrically opposed portion of the foot seat-facing surface 53 relative to the second key element 269. Although the first and second key elements 267, 269 do not have the same shape, each of the first and second key elements 267, 269 have a curved shape that corresponds to the curve defined by the foot peripheral surface 54.

The first key element 267 is shaped and dimensioned to be received in a first recess 247 of the cap portion-facing surface 44 of the movable disc 243. The first key element 267 is an arcuate protrusion that is disposed between the fifth and sixth foot openings 55(5), 55(6) and the foot peripheral surface 254. The first key element 267 extends circumferentially along the web 56 of the seat-facing surface 53 of the foot 251. The first key element 267 has a radial dimension that is greater than fifty percent of the radial distance between the fifth and sixth foot openings 55(5), 55(6) and the foot peripheral surface 54. The axial dimension of the first key element 267 is less than an axial dimension of the movable disc 243.

The second key element 269 is shaped and dimensioned to be received in a second recess 248 of the cap portion-facing surface 44 of the movable disc 243. The second key element 269 is an arcuate protrusion having an outer edge that is aligned with the foot peripheral surface 54. By this configuration, the second key element 269 extends circumferentially along the seat-facing surface 53 of the foot 251 at a location underlying the bumper arm 57. The second key element 269 has a radial dimension that is greater than fifty percent of the radial distance between the second and third foot openings 55(2), 55(3) and the foot peripheral surface 54. The axial dimension of the second key element 269 is less than an axial dimension of the movable disc 243.

As in the previous embodiment, the movable disc 243 is a rigid cylindrical plate having an axial dimension that is much less than its diameter (e.g., the movable disc 243 is disc shaped). The cap-portion-facing surface 44 of the movable disc 243 includes features that permit a mechanical engagement between the movable disc 243 and the foot 251 of the diverter driver 50. In particular, the cap-portion-facing surface 44 of the movable disc 243 includes the first recess 247 that is located, shaped and dimensioned to receive the first key element 267 of the foot 51 in a locational clearance fit. In addition, the cap-portion-facing surface 44 of the movable disc 243 includes the second recess 248 that is located, shaped and dimensioned to receive the second key element 69 of the foot 51 in a locational clearance fit.

When the driver 250 is assembled with the movable disc 243, the first key element 267 is received in and engages with the first recess 247 of the movable disc 243 and the second key element 269 is received in and engages with the second recess 248. As a result, the torque supplied by the actuator 150 to the driver 250 is transferred to the movable disc 243, whereby the movable disc 243 rotates in concert with the driver 50. More particularly, the torque is transferred to each of opposed sides of the movable disc 246.

Although, in the illustrated embodiment, the valve body 4 includes a single inlet port and two outlet ports, the rotary disc valve is not limited to this configuration. In other embodiments, the rotary disc valve includes a single outlet port. In still other embodiments, the rotary disc valve includes more than two outlet ports. In still other embodiments, the rotary disc valve includes multiple inlet ports and one or more outlet ports.

Selective illustrative embodiments of the fluid delivery system including the rotary disc valve are described above in some detail. It should be understood that only structures considered necessary for clarifying the fluid delivery system and the rotary disc valve have been described herein. Other conventional structures, and those of ancillary and auxiliary components of the fluid delivery system and the rotary disc valve, are assumed to be known and understood by those skilled in the art. Moreover, while a working example of the fluid delivery system and the rotary disc valve have been described above, the fluid delivery system and the rotary disc valve are not limited to the working example described above, but various design alterations may be carried out without departing from the fluid delivery system and/or the rotary disc valve as set forth in the claims.

1. A valve comprising:
a valve body including an inlet port and an outlet port; and
a diverter rotatably disposed in the valve body, the diverter configured to control flow through the valve body in such a way that fluid flows through the first outlet port according to a flowrate versus diverter position curve,
wherein the rate of fluid flow through the valve body can be adjusted with a first resolution for a diverter position in a first range of positions and with a second resolution for a diverter position in a second range of positions, and
the second resolution is more coarse than the first resolution.

2. The valve of claim 1, wherein
the second range of positions is non-overlapping with the first range of positions, and
each position of the second range of positions corresponds to a greater diverter position value than each position of the first range of positions.

3. A valve comprising:
a valve body including an inlet port, a first outlet port and a second outlet port;
a fixed disc disposed in and fixed relative to the valve body; and
a diverter rotatably disposed in the valve body, the diverter including a movable disc that is parallel to the fixed disc and configured to rotate relative to the fixed disc about a rotational axis, the diverter cooperating with the fixed disc to control fluid flow from the inlet port to at least one of the first outlet port and the second outlet port in such a way

That
fluid flows through the first outlet port according to a first flowrate versus diverter position curve having a first curve portion and a second curve portion that adjoins the first curve portion, the first curve portion having a first linear slope, the second curve portion having a second linear slope, wherein the second linear slope has an absolute value that is greater than the absolute value of first linear slope, and
fluid flows through the second outlet port according to a second flowrate versus diverter position curve, and the second flowrate versus diverter position curve is a mirror image of the first flowrate versus diverter position curve relative to a predetermined flowrate.

4. The valve of claim 3, wherein the predetermined flowrate intersects the second curve portion of the first flowrate versus diverter position curve.

5. The valve of claim 3, wherein
the second curve portion is non-overlapping with the first curve portion,
the fluid flow through the first outlet port is such that the flow rate for each diverter position of the second curve portion is less than the flow rate for each diverter position of the first curve portion, and
the fluid flow through the second outlet port is such that the flow rate for each diverter position of the second curve portion is greater than the flow rate for each diverter position of the first curve portion.

6. The valve of claim 3, wherein the second curve portion of the first flowrate versus diverter position curve intersects the second curve portion of the second flowrate versus diverter position curve.

7. The valve of claim 3, wherein the second curve portion of the first flowrate versus diverter position curve intersects the second curve portion of the second flowrate versus diverter position curve at a diverter position in a range of 85 percent to 95 percent of the complete range of diverter positions.

8. The valve of claim 3, wherein the predetermined flow rate is in a range of 8 (liters/min) to 12 (liters/min).

9. The valve of claim 3, wherein the first flowrate versus diverter position curve has a maximum flowrate for a diverter position in a range of 0 percent to 10 percent of the complete range of diverter positions.

10. The valve of claim 3, wherein the valve body includes a seat and a cover, wherein
the seat extends with in a plane and includes a periphery that is surrounded by an upright rim, and
the cover includes a cylindrical sidewall and a cap portion that closes one end of the sidewall,
the seat and the cover cooperating in a fluid tight manner to define a valve chamber that is configured to receive the diverter and is in fluid communication with the inlet port, the first outlet port and the second outlet port.

11. The valve of claim 10, wherein the inlet port, the first outlet port and the second outlet port are each formed in the seat.

12. The valve of claim 10, wherein
the diverter comprises a driver and the movable disc, and
the movable disc is disposed on a seat-facing surface of the driver and configured to be driven to rotate by the driver.

13. The valve of claim 10, wherein
the diverter comprises a driver and the movable disc,
the movable disc is compressed between a seat-facing surface of the driver and a cap portion-facing surface of the fixed disc, and
the movable disc is driven to rotate by the driver.

14. The valve of claim 13, wherein
the driver has a disc-shaped foot that is disposed in the valve chamber and a stem that protrudes from a cap portion-facing surface of the foot,
the stem is configured to extend through an opening in the cap portion and be mechanically connected to an actuator,
the stem has a centerline that coincides with the rotational axis, and
the diverter is configured to control fluid flow through the valve body based on a rotational orientation of the driver relative to the valve body.

15. The valve of claim 14, wherein the foot comprises a plurality of foot through openings.

16. The valve of claim 14, wherein a cap-portion-facing surface of the foot comprises a protrusion that is configured to engage with a stop element of the cover to limit an extent of rotation of the driver relative to the valve body.

17. The valve of claim 10, wherein
the fixed disc is supported on, and fixed relative to, the seat,
a sealing element is disposed between the fixed disc and the seat, the sealing element providing a fluid tight seal between the fixed disc and the seat, and
a cap portion-facing surface of the fixed disc faces and abuts a seat-facing surface of the diverter.

18. A valve comprising:
a valve body including
a first end,
a second end,
a cylindrical sidewall that extends between the first end and the second end, the first end, the second end and the sidewall together enclosing a valve chamber,
an inlet port that communicates with the valve chamber,
a first outlet port that communicates with the valve chamber, and
a second outlet port that communicates with the valve chamber;
a fixed disc that is fixed relative to the valve body and segregates the valve chamber into a first chamber portion and a second chamber portion, the fixed disc including fixed disc openings, and
a diverter rotatably disposed in the first chamber portion, the diverter including a movable disc that abuts the fixed disc and rotates relative to the fixed disc, the movable disc including a movable disc opening,
wherein the fixed disc openings and the movable disc opening are configured so that the valve controls fluid flow through the valve body is characterized in that
fluid flows through the first outlet port according to a first flowrate versus diverter position curve having a first curve portion and a second curve portion that adjoins the first curve portion, the first curve portion having a first linear slope, the second curve portion having a second linear slope, wherein the absolute value of the second linear slope is greater than the absolute value of the first linear slope, and
fluid flows through the second outlet port according to a second flowrate versus diverter position curve, and the second flowrate versus diverter position curve is a mirror image of the first flowrate versus diverter position curve relative to a predetermined flowrate.

19. The valve of claim 18, wherein each of the inlet port, the first outlet port and the second outlet port communicate with the second chamber.
